(19) United States
(12) Patent Application Publication
(10) Pub. No.: US 2006/0074676 A1
(43) Pub. Date: Apr. 6, 2006

(54) Quantitative model for formant dynamics and contextually assimilated reduction in fluent speech

(75) Inventors: Li Deng, Sammamish, WA (US); Alejandro Acero, Bellevue, WA (US); Dong Yu, Kirkland, WA (US)

Correspondence Address: WESTMAN CHAMPLIN (MICROSOFT CORPORATION), SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/944,262

(22) Filed: Sep. 17, 2004

(51) Int. Cl. G10L 13/04

(52) U.S. Cl. 704/261

(57) ABSTRACT

A method of identifying a sequence of formant trajectory values is provided in which a sequence of target values are identified for a formant as step functions. The target values and the duration for each segment target for the formant are applied to a finite impulse response filter to form a sequence of formant trajectory values. The parameters of this filter, as well as the duration of the targets for each phone, can be modified to produce many kinds of target undershooting effects in a contextually assimilated manner. The procedure for producing the formant trajectory values does not require any acoustic data from speech.

### BACKGROUND OF THE INVENTION

The present invention relates to models of speech. In particular, the present invention relates to formant models of fluent speech.

Human speech contains spectral promanances or formants. These formants carry a significant amount of the information contained in human speech.

In the past, attempts have been made to model the formants associated with particular phonetic units, such as phonemes, using discrete state models such as a Hidden Markov Model. Such models have been less than ideal, however, because they do not perform well when the speaking rate increases or the articulation of the speaker decreases.

Research into the behavior of formants during speech indicates that one possible reason for the failure of HMM based formant systems in handling fluent speech is that during fluent speech the formant values for different classes of phonetic units become very similar as the speaking rate increases or the articulation effort decreases.

Although this phenomenon, known as reduction, has been observed in human speech, an adequate model for predicting such behavior in formant tracks has not been developed. As such, a model is needed that predicts the observed dynamic patterns of the formants based on the interaction between phonetic context, speaking rate, and speaking style.

### SUMMARY OF THE INVENTION

A method of identifying a sequence of formant trajectory values is provided in which a sequence of target values of formant frequencies and bandwidths are established first, which may or may not be reached by actual formants in the trajectories. The target values for the formant are applied to a finite impulse response filter to form a sequence of formant trajectory values.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 provides a graph of observed formant values for two different vowel sounds as speaking rate increases.

FIG. 4 provides a graph of a target sequence for a formant a predicted formant trajectory using the formant model of the present invention.

FIG. 5 provides a graph of a target sequence with shorter durations than FIG. 4 and a corresponding predicted formant trajectory using the formant model of the present invention.

FIG. 6 provides a graph of predicted formant values using the model of the present invention as speaking rate increases.

FIG. 7 is a block diagram of a speech synthesis system in which the present invention may be practiced.

### DETAILED DESCRIPTION OF ILLUSTRATIVE EMBODIMENTS

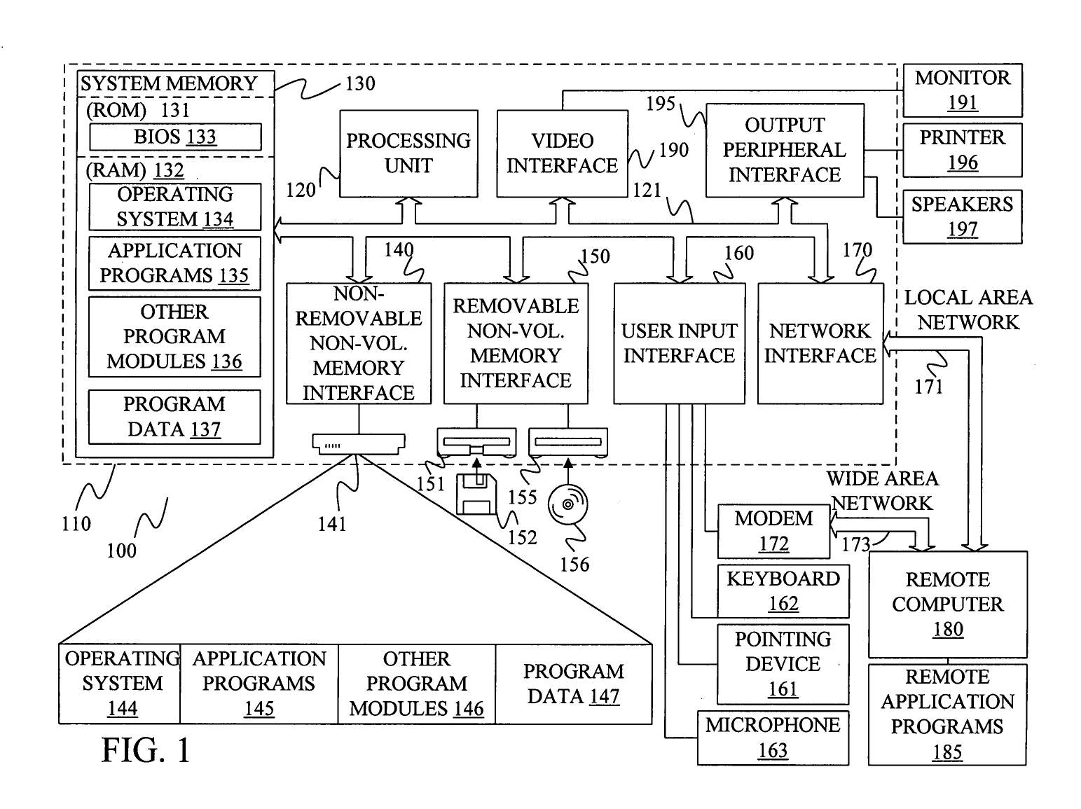

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

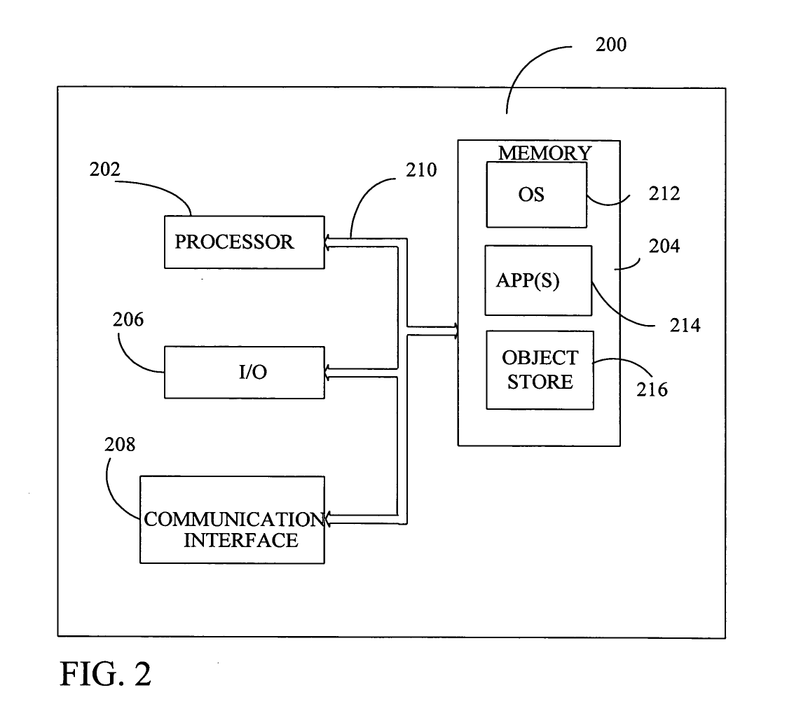

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

In the past, the failure of Hidden Markov Models to perform well on speech signals with high speaking rates or with low speaking effort has often been attributed to a lack of training data for these types of speech. The present inventors, however, have discovered that it is likely that even with more training data for these types of speech, Hidden Markov Models will still not be able to recognize speech with the desired amount of accuracy. The reason for this is that at high speaking rates the formant patterns for different vowel sounds begin to converge if only discrete portions of the speech signal are examined when making a recognition decision.

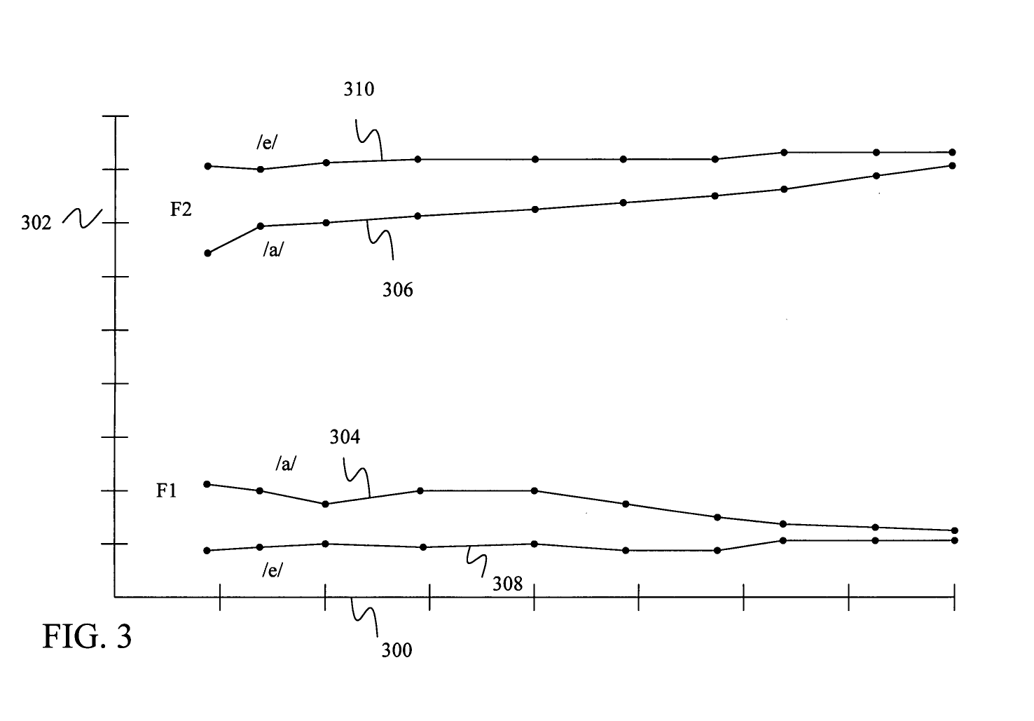

This convergence of the formant values for different vowel sounds is referred to as static confusion. FIG. 3 provides a diagram showing that as the speaking rate increases, formants for two different vowel sounds begin to converge. In particular, in FIG. 3, the speaking rate is shown on horizontal axis 300 and the frequency of the first and second formants is shown on vertical axis 302. In FIG. 3 speaking rate increases from left to right and frequency increases from the bottom to the top. The value of the first formant and the second formant for the vowel sound /a/ are shown by lines 304 and 306, respectively. The values of the first and second formant for the vowel sound /e/ are shown by lines 308 and 310, respectively.

As can be seen in FIG. 3, the first and second formants for the vowel sounds /a/ and /e/ are much more separated at lower speaking rates than at higher speaking rates. Because of this, at higher speaking rates, it is more difficult for the speech recognition system to distinguish between the /a/ sound and the /e/ sound.

The present invention provides a model for formants, which accurately predicts the static confusion represented by the data of FIG. 3. This model is a result of an interaction between phonetic context, speaking rate/duration, and spectral rate of changes related to the speaking style.

Under the model, a sequence of formant targets, modeled as step functions, are passed through a finite impulse response (FIR) filter to produce a smooth continuous formant pattern.

The FIR filter is characterized by the following non-causal impulse response function:

$${h}_{s} ( k ) \{ \begin{matrix}C {γ}_{s ( k )}^{- k} & - D < k < 0 \\ C & k = 0 \\ C {γ}_{s ( k )}^{k} & 0 < k < D\end{matrix} \qquad EQ . 1$$

where k represents the center of a time frame, typically with a length of 10 milliseconds, γₛ₍ₖ₎ is a stiffness parameter, which is positive and real valued, ranging between zero and one. The s(k) in γₛ₍ₖ₎ indicates that the stiffness parameter is dependent on the segment state s(k) on a moment-by-moment and time varying basis, and D is the unidirectional length of the impulse response.

In equation 1, k=0 represents a current time point, k less than zero represents past time points, and k greater than zero represents future time points.

Thus, in the impulse response of Equation 1, it is assumed for simplicity that the impulse response is symmetric such that the extent of coarticulation in the forward direction is equal to the extent of coarticulation in the backward direction. In other words, the impulse response is symmetric with respect to past time points and future time points. In other embodiments, the impulse response is not symmetrical. In particular, for languages other than English, it is sometimes beneficial to have a nonsymmetrical impulse response for the FIR filter.

In Equation 1, C is a normalization constraint that is used to ensure that the sum of the filter weights adds up to one. This is essential for the model to produce target “undershoot,” instead of “overshoot.” To compute C, it is first assumed that the stiffness parameter stays approximately constant across the temporal span of the finite impulse response such that:
γₛ₍ₖ₎≈γ EQ. 2

Under this assumption, the value of C can be determined for a particular γ as:

$$C \approx \frac{1 - γ}{1 + γ - 2 {γ}^{D + 1}} \qquad EQ . 3$$

Under the model of the present invention, the target for the formants is modeled as a sequence of step-wise functions with variable durations and heights, which can be defined as:

$$T ( k ) = {\sum }_{i = 1}^{P} [ u ( k - {k}_{{s}_{i}}^{l} ) - u ( k - {k}_{{s}_{i}}^{r} ) ] {xT}_{si} , \qquad EQ . 4$$

where u(k) is the unit step function that has a value of zero when its argument is negative and one when its argument is positive, kₛ^{r} is the right boundary for a segment s and kₛ^{l} is the left boundary for the segment s, Tₛ is the target for the segment s and P is the total number of segments in the sequence.

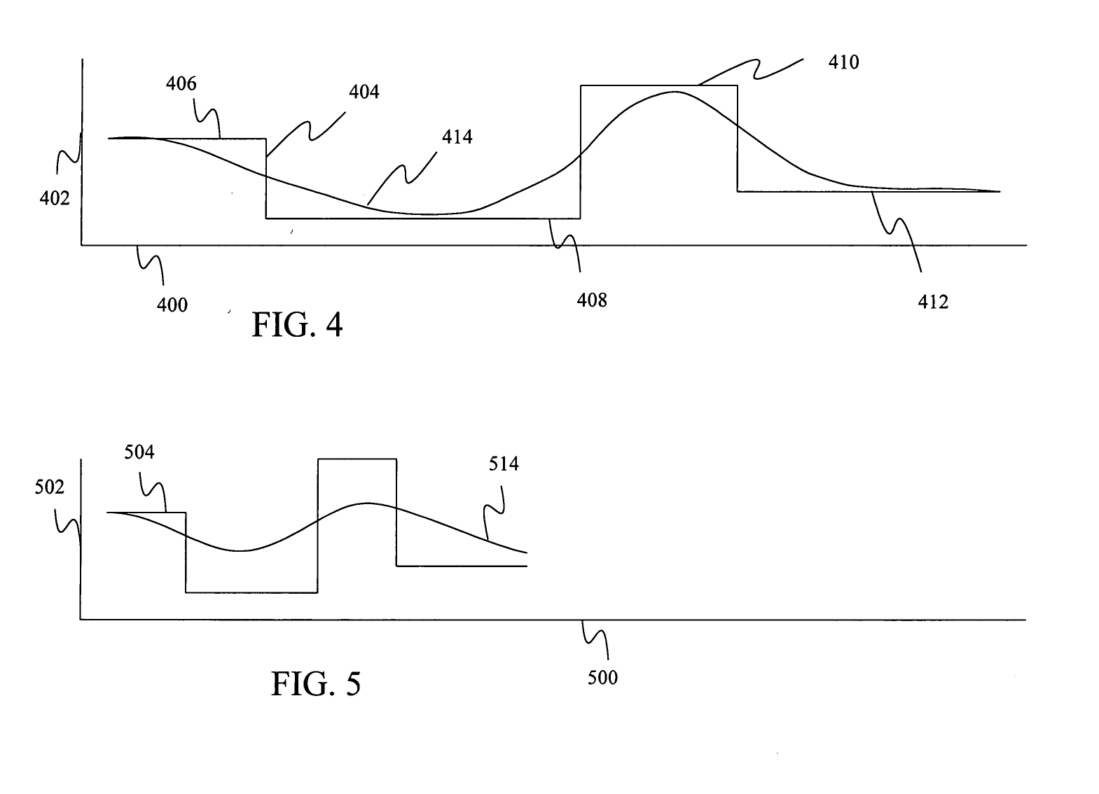

FIG. 4 provides a graph of a target sequence 404 that can be described by Equation 4. In FIG. 4, time is shown on horizontal axis 400 and frequency is shown on vertical axis 402. In FIG. 4 there are four segments having four targets 406, 408, 410 and 412.

The boundaries for the segments must be known in order to generate the target sequence. This information can be determined using a recognizer's forced alignment results or can be learned automatically using algorithms such as those described in J. Ma and L. Deng, “Efficient Decoding Strategies for Conversational Speech Recognition Using a Constrained Non-Linear State Space Model for Vocal-Tract-Resonance Dynamics,” IEEE Transactions on Speech and Audio Processing, Volume 11, 203, pages 590-602.

Given the FIR filter and the target sequence, the formant trajectories can be determined by convolving the filter response with the target sequence. This produces a formant trajectory of:

$${g}_{s} ( k ) = {h}_{s ( k )} * T ( k ) = {\sum }_{τ = k - D}^{k + D} C ( {γ}_{s ( τ )} ) {T}_{s ( τ )} {γ}_{s ( τ )}^{\vert k - τ \vert} , \qquad EQ . 5$$

where Equation 5 gives a value of the trajectory at a single value of k. In Equation 5, the stiffness parameter and the normalization constant C, are dependent on the segment at time τ. Under one embodiment of the present invention, each segment is given the same stiffness parameter and normalization constant. Even under such an embodiment, however, each segment would have its own target value T_{s(τ)}. The individual values for the trajectory of the formant can be sequentially concatenated together using:

$$g ( k ) = {\sum }_{i = 1}^{P} [ u ( k - {k}_{{s}_{i}}^{l} ) - u ( k - {k}_{{s}_{i}}^{r} ) ] \cdot {g}_{{s}_{i}} ( k ) \qquad EQ . 6$$

Note that a separate computation of Equation 6 is performed for each formant frequency resulting in separate formant trajectories.

The parameters of the filter, as well as the duration of the targets for each phone, can be modified to produce many kinds of target undershooting effects in a contextually assimilated manner.

FIG. 4 shows a predicted formant trajectory 414 developed under the model of the present invention using an FIR filter and target sequence 404 of FIG. 4. As shown in FIG. 4, the formant trajectory is a continuous trajectory that moves toward the target of each segment. For longer length segments, the formant trajectory comes closer to the target than for shorter segments.

FIG. 5 shows a graph of a target sequence and a resulting predicated formant trajectory using the present model, in which the same segments of FIG. 4 are present, but have a much shorter duration. Thus, the same targets are in target sequence 504 as in target sequence 404, but each has a shorter duration. As with FIG. 4, in FIG. 5, time is shown along horizontal axis 500 and frequency is shown along vertical axis 502.

Because of the shorter duration of each segment, the predicted formant trajectories do not come as close to the target values in FIG. 5 as they did in FIG. 4. Thus, as the duration of a speech segment shortens, there is an increase in the reduction of the formant trajectories predicted by the present model. This agrees well with the observed reductions in formant trajectories as speech segments shorten.

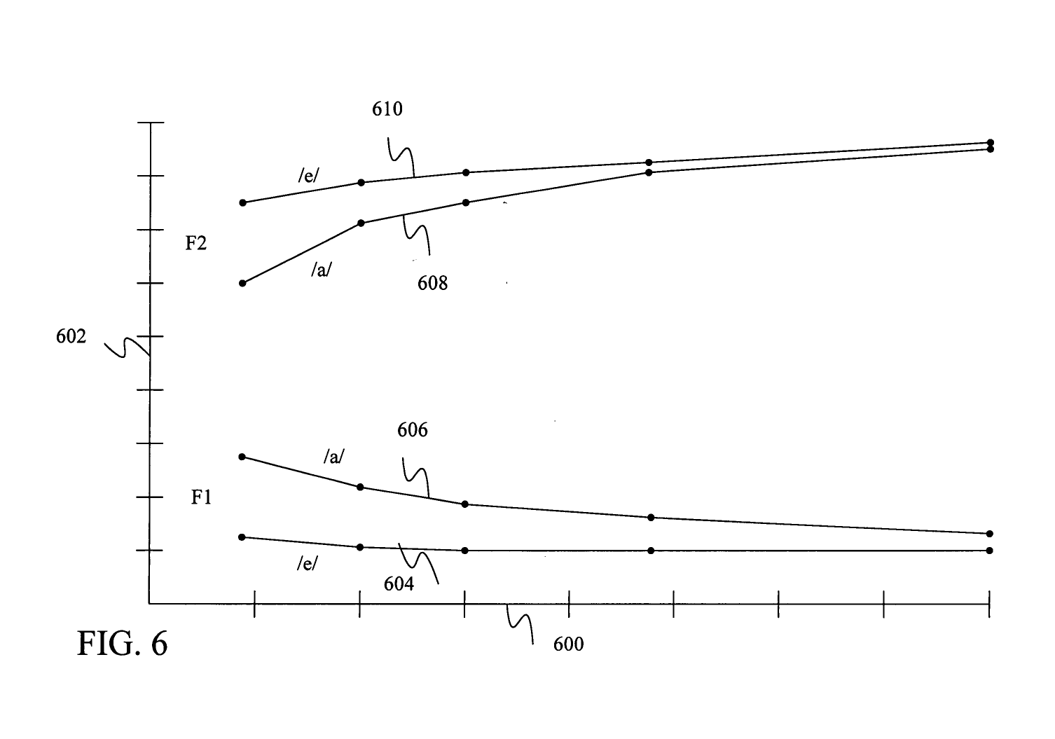

The predicted formant trajectories under the present invention also predict the static confusion between phonemes that is found in the observation data of FIG. 3. In particular, as shown in FIG. 6, the FIR filter model of the present invention predicts that as speaking rates increase the values of the first and second formants for two different phonetic units will begin to approach each other. As in FIG. 3, in FIG. 6, speaking rate is shown along horizontal axis 600 and formant frequency values are shown along vertical axis 602.

In FIG. 6, lines 604 and 610 show the values predicted by the model of the present invention for the first and second formants, respectively, of the phonetic unit /e/ as a function of speaking rate. Lines 606 and 608 show the values predicted by the model for the first and second formants, respectively, of the phonetic unit /a/.

As shown by FIG. 6, the predicted values for the first and second formants of phonetic units /e/ and /a/ converge towards each other as the speaking rate increases. Thus, the FIR filter model of the present invention generates formant trajectories that agree well with the observed data and that suggest that static confusion between phonetic units is caused by convergence of the formant values as speaking rates increase.

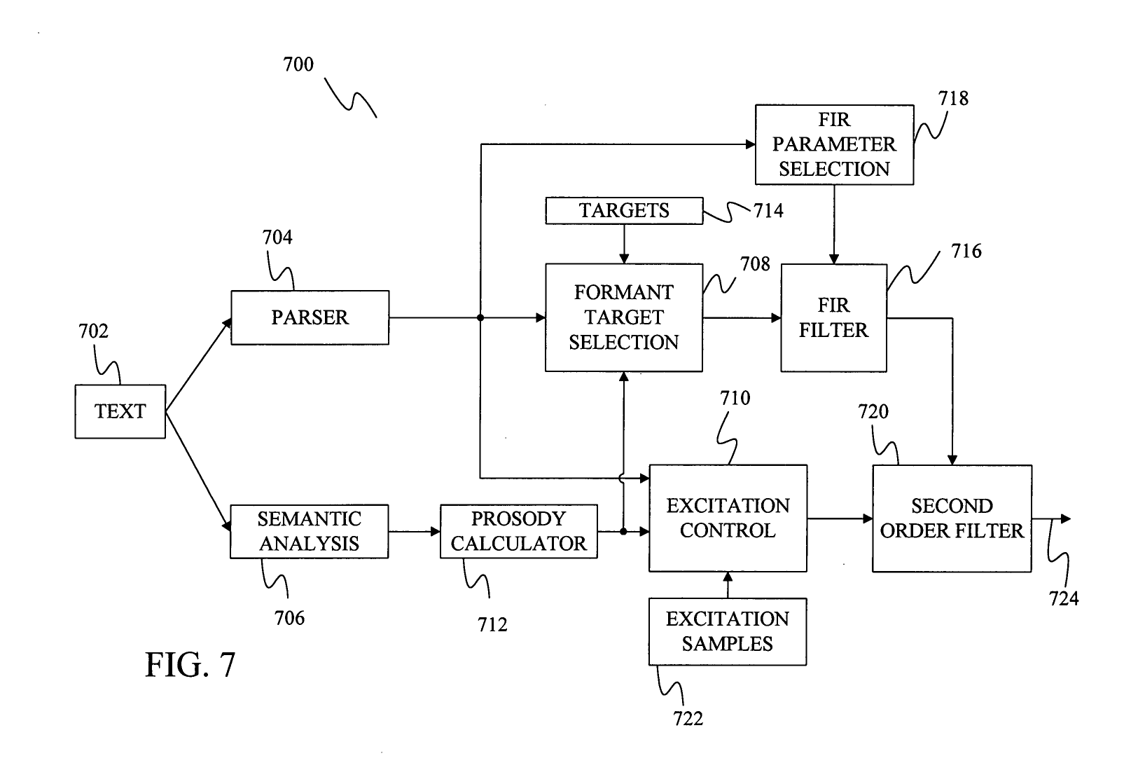

The formant trajectory model of the present invention may be used in a speech synthesis system such as speech synthesizer 700 of FIG. 7. In FIG. 7, a text 702 is provided to a parser 704 and a semantic analysis component 706. Parser 704 parses the text into phonetic units that are provided to a formant target selection unit 708 and an excitation control 710. Semantic analysis component 706 identifies semantic features of text 702 and provides these features to a prosody calculator 712. Prosody calculator 712 identifies the duration, pitch, and loudness of different portions of text 702 based on the semantic identifiers provided by semantic analysis 706. Typically, the result of prosody calculator 712 is a set of prosody marks that are provided to excitation control 710 and formant target selection 708.

Using the prosody marks, which indicate the duration of different sounds, and the identities of the phonetic units provided by parser 704, formant target selection 708 generates a target sequence using a set of predefined targets 714. Typically, there is a separate set of targets 714 for each phonetic unit that can be produced by parser 704, where each set targets includes a separate target for each of four formants.

The output of formant target selection 708 is a sequence of targets similar to target sequence 404 of FIG. 4, which is provided to a finite impulse response filter 716. The impulse response of finite impulse response filter 716 is defined according to Equation 1 above. Under some embodiments, the response is dependent on the particular phonetic units identified by parser 704. In such cases, the response of the filter is set by an FIR parameter selection unit 718, which selects the parameters from a set of stored finite impulse response parameters based on the phonetic units identified by parser 704.

The output of FIR filter 716 is a set of formant trajectories, which in one embodiment includes trajectories for four separate formants. These formant trajectories are provided to a second order filter 720.

Excitation control 710 uses the phonetic units from parser 704 and the prosody marks from prosody calculator 712 to generate an excitation signal, which, in one embodiment, is formed by concatenating excitation samples from a set of excitation samples 722. The excitation signal produced by excitation control 710 is passed through second order filter 720, which filters the excitation signal based on the formant trajectories identified by FIR filter 716. This results in synthesized speech 724.

Although the present invention has been described with reference to particular embodiments, workers skilled in the art will recognize that changes may be made in form and detail without departing from the spirit and scope of the invention.

What is claimed is:

1. A method of identifying a sequence of formant values for a sequence of phonetic units, the method comprising:
identifying a sequence of target values for a formant; and
applying the sequence of target values to a finite impulse response filter to produce a sequence of formant values.

2. The method of claim 1 wherein applying the sequence of target values to a finite impulse response filter comprises applying the sequence of target values to a finite impulse response filter that generates a value based on past target values and future target values.

3. The method of claim 2 wherein the finite impulse response is symmetrical with respect to past target values relative to future target values.

4. The method of claim 1 wherein identifying a sequence of target values comprises identifying a separate target value for each phonetic unit in the sequence of phonetic units.

5. The method of claim 1 wherein identifying a sequence of target values further comprises determining a duration for each target value in the sequence of target values.

6. The method of claim 1 wherein identifying a sequence of formant values forms part of a process for synthesizing speech.

7. The method of claim 1 wherein the response of the finite impulse response filter produces undershoot in the sequence of formant values relative to the sequence of target values.

8. A computer-readable medium having computer-executable instructions for performing steps comprising:
identifying a sequence of target formant values; and
at a point in the sequence of target formant values, determining a formant trajectory value using multiple target formant values that occur before the point in the sequence of target formant values and using multiple target formant values that occur after the point in the sequence of target formant values.

9. The computer-readable medium of claim 8 wherein determining a formant trajectory value comprises applying the sequence of target formant values to a finite impulse response filter.

10. The computer-readable medium of claim 9 wherein the response of the finite impulse response filter is dependent on a phonetic unit associated with a target formant value.

11. The computer-readable medium of claim 9 wherein the finite impulse response filter uses the same number of target formant values that occur before the point as the number of target formant values that occur after the point.

12. The computer-readable medium of claim 11 wherein the response of the finite impulse response filter is symmetrical.

13. The computer-readable medium of claim 8 wherein identifying a sequence of target formant values comprises identifying a sequence of phonetic units and identifying the sequence of target formant values from the sequence of phonetic units.

14. The computer-readable medium of claim 13 wherein identifying a sequence of phonetic units further comprises identifying a duration for each phonetic unit.

15. The computer-readable medium of claim 8 further comprising determining a sequence of formant trajectory values.

16. The computer-readable medium of claim 15 wherein the sequence of target formant trajectory values is based in part on a rate of speech and the sequence of formant trajectory values exhibits formant reduction with changes in the rate of speech.

17. A method of synthesizing speech, the method comprising:
identifying a sequence of phonetic units;
identifying a sequence of target formant values from the sequence of phonetic units;
applying the sequence of target formant values to a finite impulse response filter to form a sequence of formant trajectory values;
using the sequence of formant trajectory values to control a filter; and
applying an excitation signal to the filter to form a speech signal.

18. The method of claim 17 wherein the finite impulse response filter uses past target formant values and future target formant values to form a current formant trajectory value.

19. The method of claim 18 wherein the finite impulse response filter is symmetrical with respect to the past target formant values and the future target formant values.

20. The method of claim 18 wherein the response of the finite impulse response filter changes depending on the phonetic unit associated with the trajectory formant value.
